(19) United States
(12) Patent Application Publication
(10) Pub. No.: US 2009/0190472 A1
(43) Pub. Date: Jul. 30, 2009

(54) End-to-end network management with tie-down data integration

(75) Inventors: Cho-Leung Wong, Morganville, NJ (US); Chin-Wang Chao, Lincroft, NJ (US); Mei-Yun Chen, Marlboro, NJ (US); Hsiao-Hsien Hu, Whippany, NJ (US); David Lu, Morganville, NJ (US); Ronald Papritz, Amityville, NY (US); Sudhakar Rajapu, Edison, NJ (US)

Correspondence Address: AT&T Legal Department - HB;Patent Docketing, One AT&T Way, Room 2A-207, Bedminster, NJ, 07921, US

(73) Assignee: AT&T Services, Inc.

(21) Appl. No.: 12/011,638

(22) Filed: Jan. 28, 2008

(51) Int. Cl. G08C 15/00

(52) U.S. Cl. 370/231

(57) ABSTRACT

A method for managing tie-down information in a network management system for a telecommunications network including: providing tie-down information to the network management system associated with a plurality of tie-down demarcations using a tie-down information template comprising a plurality of tie-down information parameters associated with each of the plurality of tie-down demarcations, wherein the plurality of tie-down information parameters comprises a status; and updating the status associated with each of the plurality of tie-down demarcations based on network activity associated with the plurality of tie-down demarcations.

### FIELD OF THE INVENTION

The present invention relates to the computer based management of network systems and more specifically to the integration of network tie-down information into such network management systems.

### BACKGROUND OF INVENTION

In the modem, fast-paced and ever-changing economy, businesses have grown more dependent on networking communications that ensure uninterrupted, around-the-clock availability for their operations. The slightest connection interruption or downtime can result in unrecoverable data loss and significant increases in cost. Therefore, the network management systems operators must have access to detailed and complete network information at all times.

Most network management systems monitor the traffic on a network and the performance without regard to the infrastructure, i.e. the cables and equipment that form the network, and the tie-down information. Therefore, when a problem is encountered that requires the tie-down information relating to cables and/or equipment, the network operators must look outside the network management system to access this information. Typically, this tie-down information is available in equipment lists and cable input/output lists that have been printed out or that reside in a separate computer database that cannot be accessed from the network management system. For example, the “tie-down” information for some networks is often listed in ring design package (“RDP”) Excel files that are not accessible from the network management system. In order for the information to be used for network management operations, it has to be manually integrated with the network management information by the network operators. Not only is this procedure inefficient but it also requires an inordinate amount of time to complete.

As used herein, the terms “tie-down information” (“TDI”), “tie-down data” and “tie-downs” refer to a listing of information pertaining to network demarcations and are used interchangeably. In telephony, the demarcation point is the point at which the telephone company network ends and connects with the wiring at the customer premises. Network demarcations reference the locations (e.g., city, address, floor, aisle, bay, panel, and jack) of the network connections between the network operator and a customer premise or between the network operator and a third party service provider. The tie-down data are an integral part of network management but currently these data are created, inventoried and tracked in a non-systematic manner (e.g., using computer based spreadsheets and/or other editing tools), external to the network management systems. This means that a network operator does not have direct access to tie-down information.

The manual management of tie-down information is error prone because there is no easy way to determine if the tie-down information is correct without physically inspecting each tie-down point. Also, the decentralized management between the service network via the operations support system and the associated tie-down demarcations on a separate database (using manual efforts) often creates operational gaps that result in prolonged provisioning cycle time, delay in service maintenance and customer dissatisfaction. An even more serious problem with the methods that are currently used to track tie-down information is the lack of dynamic feedback information.

Accordingly, there is a need for a method that incorporates tie-down information into the network management system so that the tie-down demarcations can be easily accessed and tracked dynamically based on network activity. In addition, there is a need for a network management system that acts as the single data repository for the tie-down information in order to efficiently support various network reporting, provisioning and maintenance activities.

### SUMMARY OF THE INVENTION

In accordance with the present invention, a method of managing tie-down information associated with a telecommunications network using a network management system is provided. The method include: providing tie-down information to the network management system associated with a plurality of tie-down demarcations using a tie-down information template comprising a plurality of tie-down information parameters associated with each of the plurality of tie-down demarcations, wherein the plurality of tie-down information parameters comprises a status; and updating the status associated with each of the plurality of tie-down demarcations based on network activity associated with the plurality of tie-down demarcations.

In another embodiment, the present invention is a computer-readable medium that includes instructions, wherein execution of the instructions by at least one computing device manages tie-down information associated with a telecommunications network using a network management system. The execution of the instructions manages tie-down information by providing tie-down information to the network management system associated with a plurality of tie-down demarcations using a tie-down information template comprising a plurality of tie-down information parameters associated with each of the plurality of tie-down demarcations, wherein the plurality of tie-down information parameters comprises a status; and updating the status associated with each of the plurality of tie-down demarcations based on network activity associated with the plurality of tie-down demarcations.

Another embodiment of the present invention is a method for integrating and dynamically updating tie-down information in a network management system for a telecommunications network. The method includes: creating a tie-down information template, wherein the template comprises a plurality of tie-down information parameters; adding the plurality of tie-down information parameters associated with a plurality of tie-down demarcations to a network management system using the template; monitoring network traffic associated with the plurality of tie-down demarcations; determining a status associated with the plurality of tie-down demarcations based on network activity; and updating the status of the plurality of tie-down demarcations based on network activity. The method can also include compiling tie-down information for a plurality of tie-down demarcations, wherein the tie-down information includes a plurality of tie-down information parameters such as a status.

The tie-down information parameters can include shelf designation, slot designation, sub-slot designation and port designation. The tie-down information parameters can also include node, card, port, link and connection information and the tie-down demarcations can include optical circuits, electrical circuits or optical circuits and electrical circuits. Preferably, the network management system includes a network support system and the tie-down information is added to the network support system.

Once entered into the network management system, the plurality of tie-down information parameters can be used for generating reports, provisioning services, maintaining network inventory, configuring network components or managing network faults. Once the TDI is imported into the management system, the system will serve as the database of record for maintaining the TDI data. Therefore, no further manual tracking of the TDI is needed. If changes are to the TDI are required, they can be made via the system graphical user interface (“GUI”). The method also includes preparing reports that include tie-down information and network activity such as network traffic. These reports can include customer number, facility location or type of circuit. When the reports list tie-down demarcations by the status, the status can be “in-use,” “reserved” or “spare.”

The tie-down information parameters for tie-down demarcations can be downloaded into the templates from a ring design package (“RDP”) Excel file. Preferably, the tie-down information parameters are added from a remote database into the network management system or manually entered into the tie-down information template via a network terminal. The network activity used for updating the status of the plurality of tie-down demarcations is preferably the network traffic. The network management system can include a database and the tie-down information parameters for the plurality of tie-down demarcations can be stored on the database. The telecommunications network can include one or more other network management systems and these other network management systems can access the tie-down information parameters for the plurality of tie-down demarcations in the database via the telecommunications network.

### BRIEF DESCRIPTION OF THE FIGURES

The preferred embodiments of the integrated network management system of the present invention, as well as other objects, features and advantages of this invention, will be apparent from the accompanying drawings wherein:

FIG. 1 shows a tie-down import template that is used for entering tie-down information into a network management system.

FIG. 2 shows a Tie-Down Summary report for a customer's circuits.

FIG. 3 is a flow chart showing how information is added to the OSS using a template and then accessed using an operator console.

### DETAILED DESCRIPTION OF THE INVENTION

The present invention provides a method that allows network operating systems to quickly and efficiently access and manage tie-down information in a network management system. The method establishes an inventory database of tie-down information and integrates tie-down information with non-tie-down data from the service provider's network in the network management Operation Support System (“OSS”), which is also referred to herein as the “network management system.” After the service provider's non-tie-down data in the OSS is enhanced with the tie-down data, it can be used to support end-to-end network management operations. As used herein, an OSS is a computer system used by a telecommunications service provider to manage a telecommunications network. The OSS supports processes such as maintaining network inventory, provisioning services, configuring network components, and managing faults.

The method of the present invention creates a centralized system inventory of tie-down data and integrates the tie-down data with the network data in one system to more effectively support operations activities. Typically, telecommunications networks are managed by network OSS with a logical network model, which represents the managed resources in an intelligent network. The intelligent network resources have the capability to communicate with the OSS via a data communications network for data exchange in support of network discovery and provisioning functionalities. The OSS does not usually manage the passive devices (e.g., tie-down points, main distribution frame, filters, etc.) because the passive devices do not have active components that need to be managed by the OSS and they do not provide feedback signals that would support remote communication capability. Consequently, the OSS cannot “see” the passive devices such as tie-downs and they are transparent to the OSS. For example, the OSS cannot confirm that a cable is actually connected to the network.

The method of the present invention enables the OSS to “see” the tie-down demarcations by integrating the existing network model and the tie-down data in one system. The method includes data entry using a template to import tie-down data from existing files either by linking the databases or by entering the tie-down data via a human-machine interface. Once the tie-down data is entered, it is accessible for data exchange with other OSS in the network via machine-machine interface. Once the tie-downs are imported and inventoried in the OSS, the network model provides the OSS with access to the inventoried tie-downs. This allows the user to manage the service network and its demarcation seamlessly. More importantly, the tie-down integration using the logical network model enables automated management of tie-down information. For instance, tie-down status can be created to identify the status of the tie-down, i.e. whether a tie-down demarcation is in use, reserved or spare. This allows the status of the tie-down demarcations to be updated automatically based on network activity. For example, traffic over a network circuit indicates that the corresponding tie-down demarcation for the circuit is in use.

The OSS with the integrated tie-down information provides end-to-end management of a service network and the tie-down demarcations for the network by managing the tie-down demarcations as part of the OSS data management. The method eliminates the manual activities for tracking and managing tie-down data and integrates network management to optimize the operations processes and shorten the operations cycle time. This reduces the inventory errors in the tie-down data that are introduced by human error. The method also reduces the manual activities required in the day-to-day operations activities (i.e., service provisioning and maintenance) related to tie-down information and thereby improves the operations cycle time. In addition, the method provides an inventory model that integrates tie-down demarcations with the service network and thereby enables the development of applications to support various operations activities.

A typical OSS used in the method of the present invention provides integrated and automated network discovery and provisioning across multi-vendor/multi-technology platforms. The system includes a windows-based graphical user interface (“GUI”) that allows point and click network provisioning activities via an operator console, as well as a consolidated view of network components. The OSS also includes asset inventory for network equipment, network facility, tie-down information, Layer 1 and Layer 2 transport as well as, the physical and logical connectivity of the network circuits.

A preferred OSS for the present invention is the AT&T GFP-UVNS Ultravailable®Net View (referred to herein as “Net View”), which is an enhanced graphical user interface display for network map, network topology information, network alarm information and reporting capabilities. This system provides network users (i.e. external customers and global client support center operation associates) with network status (e.g., network topology view, alarm dashboard) and inventory reports for optical network service assurance. Net View supports the display of tie-down data in the existing inventory and provides reports such as a port utilization report, a provisioned connection report, a hardware inventory report and a synchronous optical networking (“SONET”) bandwidth utilization report. The present invention expands the capabilities of the system to support an inventory report which includes active information for tie-down demarcations and their associated data.

The method monitors the status of network tie-down information so that the global client support center can monitor which tie-downs are in-use (i.e., the circuit attached to that tie-down is “in service”), which are reserved for a pending customer order and which are spare. The data import facility in the OSS is enhanced to support the new information fields defined by the method. The inventory data model is also enhanced to capture the status of a tie-down and other additional related data fields. Typically, the source of the tie-down import data is a file created in a computer file, such as the ring design package (“RDP”) files. Once imported into the network management system, the tie-down data can be viewed from a variety of different locations on the network, e.g. in the network manager, link manager and connection manager. The tie-down data can also be displayed in inventory reports and exported to remote locations. A report can also be provided that displays the tie-downs along with their status and date. The method reduces the time and expense associated with tracking the status of the tie-downs and streamlines the process for re-loading extracted data into the OSS inventory database. Moreover, the imported tie-down data can be used by the network management system to support network operations.

Tie-down data are imported into the network management system using a template that defines the parameters of the tie-down information as well as other information about the circuit. The TDI relates to the demarcation point between the network and a customer or another network. The other information entered in the template includes non-TDI data relating to the termination on the network side of the circuit and specific circuit data. After the template information is entered in the OSS database, the OSS associates and integrates the combined TDI and non-TDI data using information available on the network management system. This TDI integrated information enables the OSS to associate and monitor network information and TDI and periodically updates TDI based on network activity. For example, when a tie-down is imported into the OSS, it can initially be associated with an un-used port of an intelligent network element (INE) and the tie-down is designated as “spare.” After a period of time, a new business order uses this port for a circuit. Once the port is provisioned for the new circuit and the circuit is placed in service, the port becomes an “in-service” port and the pertaining tie-down is no longer a “spare.” The network management system monitors the new circuit and discovers that the status of the port has changed. The OSS then uses this information to update the TDI for the port and change its status from “spare” to “in-use.”

In order to standardize the tie-down information for the network, a unified format (e.g., a template) is defined for specifying tie-down data parameters for the tie-down information. The template contains entries for various tie-down parameters that identify the location of the tie-down demarcation of a circuit. The parameters can include a shelf designation, a slot designation, a sub-slot designation and a port designation. The standardized template format is used for data entry on a human-to-machine interface and/or data exchange on a machine-to-machine interface. After the tie-down data is entered using the template, it is integrated with the network management OSS. The OSS inventory data can be used as the database of record for tie-down data, which eliminates the manual activities associated with tie-down inventory tracking.

After the tie-down data is entered in the OSS, the network manager can create programs for processing tie-down data in the OSS and generating reports. The data processing programs in the OSS system can include programs for exporting tie down data from the system, deleting tie-down data, and editing tie-down data. When the tie-down data is entered in the OSS, it is also integrated with non-tie-down data pertaining to the circuit, such as information relating to the type of circuit and the location of the connection on the network side of the cable. The integrated tie-down information can be displayed by network system users in a variety of formats which are determined by the particular needs of the user. The different formats for the presentation of tie-down data are primarily based on operations applications.

At user command, a tie-down inventory report can be provided containing the following TDI data: node name, network connection name, node location (street address, city, state), connection service type, node card, node slot, node port, network bay, network panel, network jack, network status, network status date, core (access) circuit for active. Typically, the tie-down report is sorted by first the node location via state, then city, then street address; and then by node name, slot name, port name and lastly connection name. The system also provides the user a capability to export the inventory report data to a Microsoft Excel file. The tie-down information can be used to prepare other reports based on specific customer requirements.

The shelf, slot, sub-slot, port parameters are used by the system to identify the target port for the TDI connection. The circuit parameter is used by the system to determine the TDI patch panel type (e.g., electrical vs. optical). For the optical circuits, transmit (“TX”) and receive (“RX”) ports are entered in the template consecutively as two separate entries. For electrical circuits, the ports are expected to be bi-directional, i.e. transmit-receive (“TR”), and are entered in single entries.

The TDI parameters are stored by the system as nodes, cards, port, links, and connections. The patch panel node is identified by the FIC/Bay and panel identifiers. The jack is the port in the system which is used by the system to establish the tie-down links and connections. The circuit ID parameters are stored by the system along with the user provisioned connection that is associated with the target port on the shelf. The shelf, slot, sub-slot, port parameters are used by the system to identify the target port for the TDI connection. The circuit ID parameters are stored by the system along with the user provisioned connection that is associated with the target port on the shelf. The following circuit types are supported by the system: DS-1, DS1, DS-3, DS3, OC-3, OC3, OC-12, OC12, OC-48, OC48, OC-192, OC192, GIGE, GE, FE, FastEthernet, FibreChannel, FiberChannel, FICON, FICON Express, ESCON, Subrate Multiplex, ETR, Async FOTS, ISC, FDDI, ATM 155 Mb and SRM.

In a preferred embodiment, the present invention is a computer-readable medium that includes instructions. The execution of the instructions by at least one computing device manages the tie-down information associated with a telecommunications network using the network management system. As used herein, the phrase “computer-readable medium” refers to any means or medium for storing information encoded in a form that can be read, scanned sense or executed by a machine or computer and can include any kind of computer memory such as floppy disks, conventional hard disks, CD-ROMS, Flash ROMS, nonvolatile ROM and RAM.

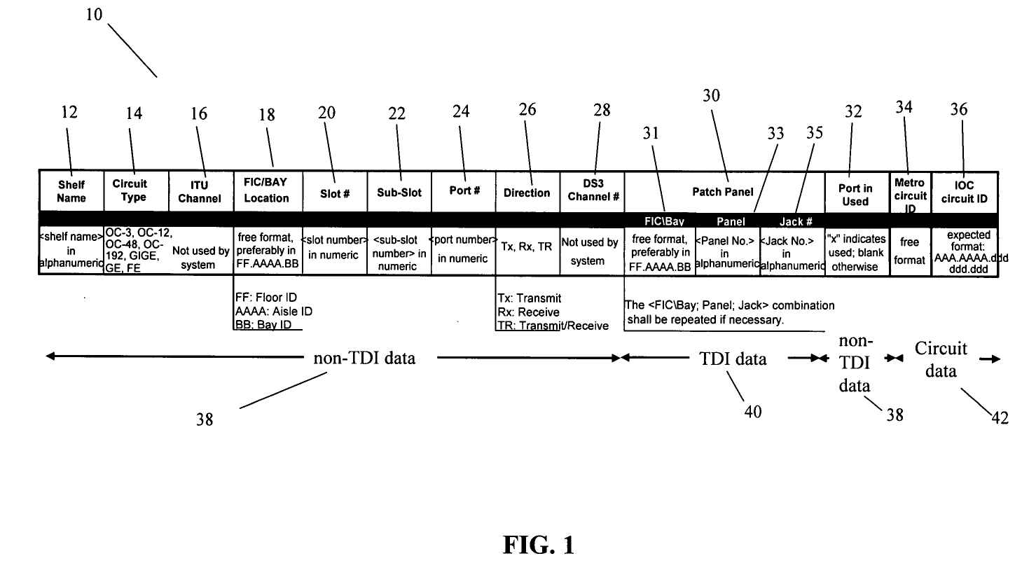

Referring now to the drawings, FIG. 1 shows a tie-down import template 10 that includes non-TDI data 38, TDI data 40 and circuit data 42. The template 10 is constructed so that detailed information about tie-down demarcations can be easily entered via an operator console. The non-TDI data 38 includes columns that list the shelf name 12, circuit type 14, ITU channel 16, FIC/Bay location 18, slot number 20, sub-slot 22, port number 24, direction of the signal 26, DS3 channel number 28 and “port in used” 32. The non-TDI data 38 represent the interface of the tie-down connection to an intelligent network element (NE), i.e., the connection on the network side of the cable. An example of this type of interface is an OC-3 port on an optical node, such as a Cisco ONS 15454. Each non-TDI data interface is uniquely identified by a port number with respect to a card inside a shelf.

The non-TDI data 38 entered in the template 10 includes the shelf name 12, which is entered in column one in an alphanumeric format, and the type of circuit 14 which is entered in column two. When the system includes an ITU channel 16, this information is entered in column three. The FIC/Bay location 18 is entered in column four in a free format that includes the location of the floor, the aisle and the bay. A numeric slot number 20, a sub-slot number 22 and port number 24 are entered in columns five, six and seven, respectively. The direction 26 of the signal is entered in column eight. Typically, the direction 26 is listed as TX for transmit, RX for receive and TR for transmit/receive. When the system includes a DS3 channel number 28, the information is entered in column nine of the template 10.

The TDI data 40 defines the tie-down point at the customer side of the cable connection. For example, the tie-down can be associated with one or more patch panels. The TDI data 40 is entered in columns ten and eleven. Information pertaining to the patch panel 30 is entered in the three sub-columns 31, 33, 35 of column 10. The information entered defines the physical location of the tie-down demarcation and includes an alphanumeric designation for the FIC/Bay 31, the panel 33 and the jack number 35. Column eleven is for “port in used” 32 and it is non-TDI data which indicates whether or not the intelligent network element (“INE”) port is used for a connection. An “x” is entered in the column when the input port is used for the connection.

The circuit data 42 is entered in the last two columns (columns twelve and thirteen) of the template 10. The metro circuit ID 34 is entered in column twelve and the inter-office connection (“IOC”) circuit ID is entered in column thirteen. This information pertains to the third party circuit that is connected to the network via the tie-down demarcation.

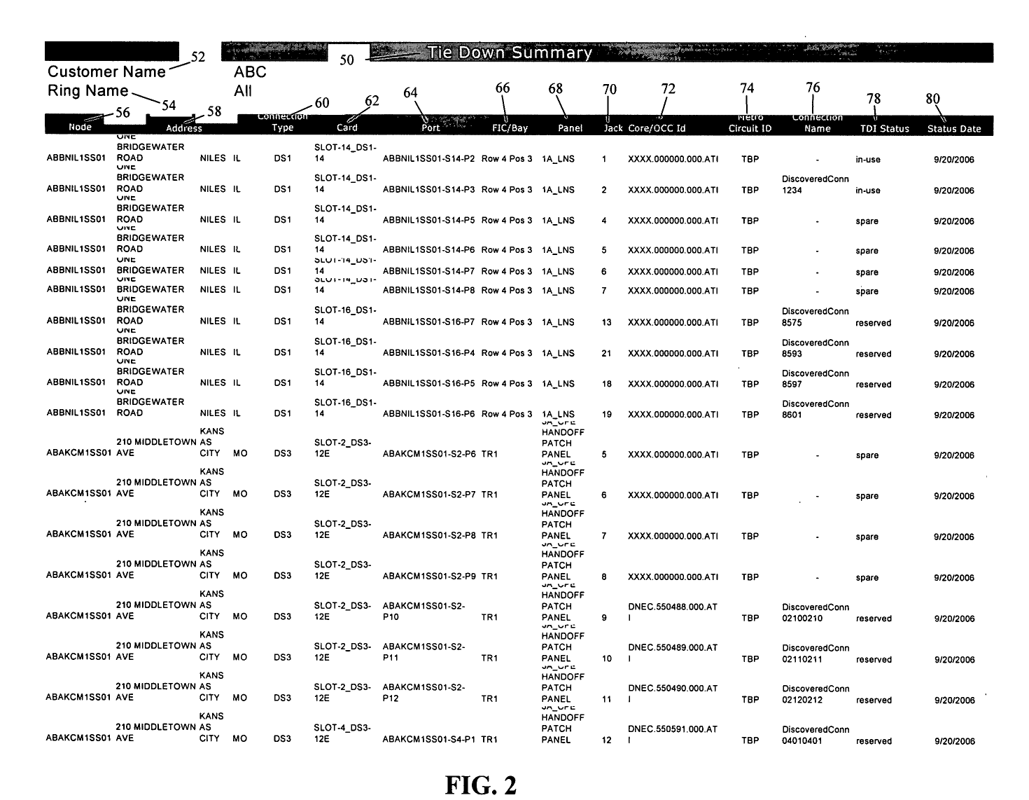

FIG. 2 shows a detailed report of the Tie-Down Summary 50 for a customer. The customer name 52 is shown as “ABC” and the ring name 54 for the report is “All,” which means that all of the rings for customer ABC are listed in the Summary 50. The Tie-Down Summary 50 lists information for each of the customer's tie-down demarcations. The first column identifies the node 56 on the network. The second column lists an address 58 by street and city where the node 56 is physically located. The third column lists the connection type 60, i.e. the type of circuit that is connected to the system. The fourth column lists the card 62 for the connection and the fifth column lists the port 64. The sixth and seventh columns list the FIC/Bay 66 and panel 68, which identifies where a tie-down patch panel is located. The jack number 70 in the eighth column identifies the jack for the corresponding port 64.

The ninth column lists the core/OCC ID 72, which identifies the core network connection, i.e., the core network traversed by the end-to-end customer circuit. The metro circuit ID 74 in column ten provides information about a third party network circuit that is used for carrying part of the end-end traffic of a telecom network. The connection name 76 in column eleven lists the name of the customer connection. Columns twelve and thirteen of the Tie-Down Summary 50 list the TDI status 78 and status date 80 of the tie-down point. Typically, the status is listed as either “in-use,” “reserved” or “spare.”

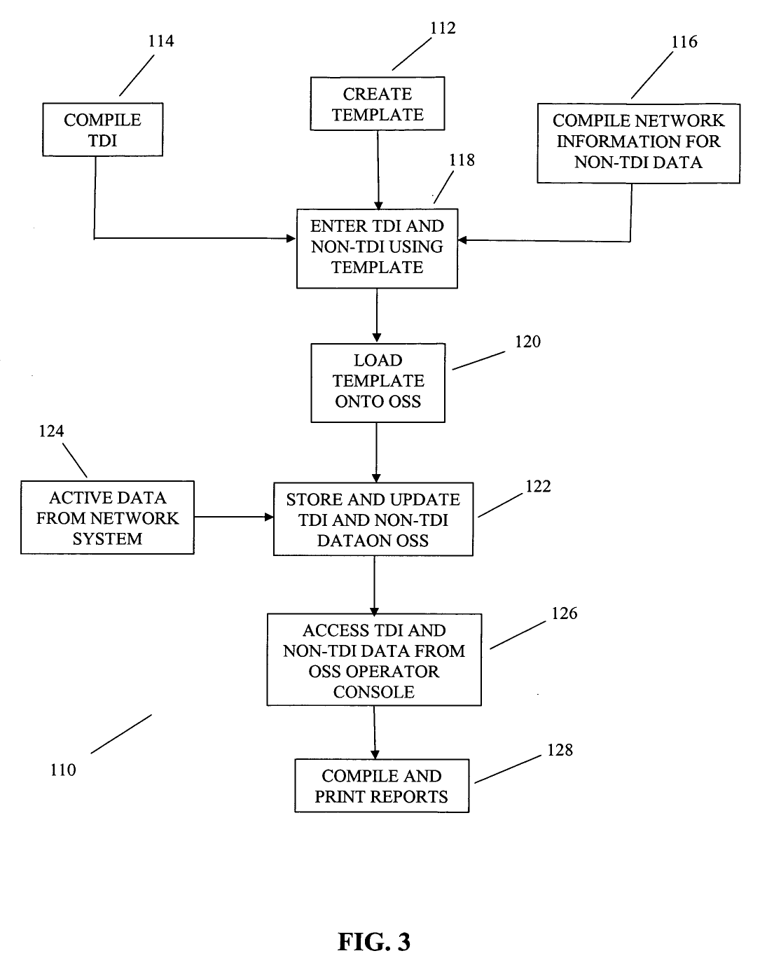

FIG. 3 is a flow chart 110 showing how the TDI information is integrated with non-TDI system data. A template is created 112 which contains entries for both TDI and non-TDI data (see FIG. 1). The TDI is compiled 114 and the non-TDI data is compiled 116 for the network system and entered using the template 118 for each tie-down demarcation. After the information is entered using the template 118, it is loaded onto the OSS 120 where it is stored and updated 122 using active data from the network 124. The stored TDI and non-TDI information 122 can be accessed using an OSS operator console 126. The information can then be used for compiling reports 128 as well as provisioning services, maintaining network inventory, configuring network components and managing network faults.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A method of managing tie-down information associated with a telecommunications network using a network management system, the method comprising:
providing tie-down information to the network management system associated with a plurality of tie-down demarcations using a tie-down information template comprising a plurality of tie-down information parameters associated with each of the plurality of tie-down demarcations, wherein the plurality of tie-down information parameters comprises a status; and
updating the status associated with each of the plurality of tie-down demarcations based on network activity associated with the plurality of tie-down demarcations.

2. The method of managing tie-down information according to claim 1, wherein the tie-down information parameters comprise at least one of a shelf designation, a slot designation, a sub-slot designation and a port designation.

3. The method of managing tie-down information according to claim 1, wherein the plurality of tie-down demarcations comprises at least one of optical circuits and electrical circuits.

4. The method of managing tie-down information according to claim 1, wherein the network management system comprises a network support system and the tie-down information is provided to the network support system.

5. The method of managing tie-down information according to claim 1, wherein the plurality of tie-down information parameters is used for at least one of generating reports, provisioning services, maintaining network inventory, configuring network components and managing network faults.

6. The method of managing tie-down information according to claim 1, wherein each of the plurality of tie-down information parameters for a tie-down demarcation comprises at least one of node, card, port, link and connection information.

7. The method of managing tie-down information according to claim 1, wherein the plurality of tie-down information parameters for the plurality of tie-down demarcations is downloaded into the templates from a ring design package (“RDP”) Excel file or manually entered into the tie-down information template.

8. The method of managing tie-down information according to claim 7, wherein the network activity used for updating the status of the plurality of tie-down demarcations is network traffic.

9. The method of managing tie-down information according to claim 8, further comprising preparing a report comprising tie-down information and network traffic.

10. The method of managing tie-down information according to claim 9, wherein the report is based on customer number, facility location or type of circuit.

11. The method of managing tie-down information according to claim 9, wherein the report lists tie-down demarcations by status and wherein the status is in-use, reserved or spare.

12. The method of managing tie-down information according to claim 1, wherein the network management system comprises a database and wherein the tie-down information parameters for the plurality of tie-down demarcations are stored in the database.

13. The method of managing tie-down information according to claim 12, wherein the telecommunications network comprises one or more other network management systems, and wherein the one or more other network management systems can access the tie-down information parameters for the plurality of tie-down demarcations in the database via the telecommunications network.

14. A computer-readable medium comprising instructions, wherein execution of the instructions by at least one computing device manages tie-down information associated with a telecommunications network using a network management system by:
providing tie-down information to the network management system associated with a plurality of tie-down demarcations using a tie-down information template comprising a plurality of tie-down information parameters associated with each of the plurality of tie-down demarcations, wherein the plurality of tie-down information parameters comprises a status; and
updating the status associated with each of the plurality of tie-down demarcations based on network activity associated with the plurality of tie-down demarcations.

15. The computer-readable medium comprising instructions according to claim 14, wherein the tie-down information parameters comprise at least one of a shelf designation, a slot designation, a sub-slot designation and a port designation.

16. The computer-readable medium comprising instructions according to claim 14, wherein the plurality of tie-down demarcations comprises at least one of optical circuits and electrical circuits.

17. The computer-readable medium comprising instructions according to claim 14, wherein the network management system comprises a network support system and the tie-down information is provided to the network support system.

18. The computer-readable medium comprising instructions according to claim 14, wherein the plurality of tie-down information parameters is used for at least one of generating reports, provisioning services, maintaining network inventory, configuring network components and managing network faults.

19. The computer-readable medium comprising instructions according to claim 14, wherein each of the plurality of tie-down information parameters for a tie-down demarcation comprises at least one of node, card, port, link and connection information.

20. The computer-readable medium comprising instructions according to claim 14, wherein the plurality of tie-down information parameters for the plurality of tie-down demarcations is downloaded into the templates from a ring design package (“RDP”) Excel file or manually entered into the tie-down information template.

21. The computer-readable medium comprising instructions according to claim 14, further comprising preparing a report comprising tie-down information and network traffic.

22. The computer-readable medium comprising instructions according to claim 21, wherein the report is based on customer number, facility location or type of circuit.

23. The computer-readable medium comprising instructions according to claim 21, wherein the report lists tie-down demarcations by the status and wherein the status is in-use, reserved or spare.

24. The computer-readable medium comprising instructions according to claim 14, wherein the network management system comprises a database and wherein the tie-down information parameters for the plurality of tie-down demarcations are stored in the database.

25. The computer-readable medium comprising instructions according to claim 24, wherein the telecommunications network comprises one or more other network management systems, and wherein the one or more other network management systems can access the tie-down information parameters for the plurality of tie-down demarcations in the database via the telecommunications network.
